(19) United States
(12) Patent Application Publication
(10) Pub. No.: US 2025/0285085 A1
(43) Pub. Date: Sep. 11, 2025

(54) Artificial Intelligence Text Scheduling Method

(71) Applicant: Financial AI Corp., Alpharetta, GA (US)

(72) Inventor: Christopher Hoffman, Alpharetta, CA (US)

(73) Assignee: Financial AI Corp., Alpharetta, GA (US)

(21) Appl. No.: 19/051,377

(22) Filed: Feb. 12, 2025

Related U.S. Application Data
(60) Provisional application No. 63/562,843, filed on Mar. 8, 2024.

(51) Int. Cl. G06Q 10/1093; G06Q 10/0631; G06Q 30/015

(52) U.S. Cl. CPC G06Q 10/1095; G06Q 10/06311; G06Q 30/015

(57) ABSTRACT

An automated texting platform contacts clients and potential clients inviting them to set up an appointment with a company. At least a portion of a person's availability at the company is shown to the client/prospective client to select an appointment time/location. When the appointment is selected, the CRM module is updated in real time to show the appointment (so that no one else may schedule that time/person/location). Prospective clients may have GIF files, if not full video or links provided to their phone to introduce the company and provide appointment options.

### CLAIM OF PRIORITY

This application claims the benefit of U.S. Provisional application Nos. 63/562,843 filed Mar. 8, 2024 and 63/562,848 filed Mar. 22, 2024, and which are both incorporated by reference herein in their entirety.

### Field of the Invention

The present invention relates to an automated system to permit clients/potential clients to schedule appointments with specific individuals of a company at available times in those individuals schedule which is updated in real time to prevent double-booking.

### BACKGROUND OF THE INVENTION

Many companies struggle with scheduling issues. Many times, a company representative calls, leaves a message and waits for a potential customer to call and them then schedule a mutually good time for a future appointment.

Other times, a company representative will leave messages or emails advising that they have ability for a meeting in a range or window which overlap with similar messages/emails left with other parties in an effort to fill their calendar. A problem arises when one party schedules a meeting in that window which may overlap at least partially with a commitment scheduled with another party for that customer representative.

If the company representative catches the double booking, they then must follow up and work out the conflict, which takes time and can be frustrating.

Accordingly, a need exists to more efficiently schedule meetings for company representatives, particularly with customers or potential customers.

### SUMMARY OF THE INVENTION

It is a present object of many embodiments of the present invention to automate the selection of an appointment by a customer/potential customer to update a company representative's calendar or CRM software in real time to prevent double booking across the appointment by a later booked appointment.

It is another object of many embodiments of the present invention to provide a text to a customer/potential customer providing a portion of a calendar showing available appointment times/locations thereby permitting the customer/potential customer to select, and when an appointment selection is made, updating the calendar in real time so that if available appointment times/places are shown to another, they do not include the appointment selection, or if they are viewing potential times and some of that time becomes unavailable (due to selection by another or removal by the company representative, such as if they schedule something in that time), the potential times are updated in real time to remove the unavailable time.

Accordingly, in accordance with a presently preferred embodiment of the present invention, a text message is sent to a customer or potential customer or a particular company. If a potential customer, the text message may include at least some graphics related to the company, such as a GIF file, or even a full video file, etc. The text invites the customer/potential customer to open a customer representative's calendar, such as from their CRM, showing the customer/potential customer at least some dates/times/locations available for booking an appointment with that representative. Those time slots not available are preferably blocked out without significant detail so the customer/prospective customer does not have information related to other meetings other than the company representative is not available at certain times.

If a date/time/location becomes unavailable before being selected by that person, that date/time/location is removed as an unavailable time slot in real time so that the user does not attempt, whether inadvertently or otherwise, to book overlapping time slots to create double booking for the company representative. Of course, the software could also analyze if multiple locations are involved (such as if the representative travels between locations for meetings), and add in the appropriate travel time to become unavailable as well when the appointment is booked.

With the booking of the appointment through the text message system while automatedly updating the customer representative's CRM and/or calendar, the customer representative is not double booked and is not spending time communicating back and forth with a customer/potential customer about when would be a good time/location to meet.

In the texting platform the user (i.e., customer or potential customer), may click on a link which cooperates with their company representative's calendar (preferably without seeing at least some information relating to who the company representative is meeting with at other times) to select from the available time slots of the company representative that works for the customer/potential customer. It is possible that the customer/potential customer may input their zip code and multiple customer representative's calendar's may be made available as discussed a above, or a single representative's calendar may appear, depending upon the criteria set by the company and/or selected by the customer/potential customer.

It is possible that a remote meeting such as through Zoom, TEAMS, etc. may be scheduled. With known conflicts blocked off, the use, aka the customer or potential user may select times/dates that work best for the company representative. It may also be possible for the user/potential to change the location and/or chose from any/all available office of the company, or various company representatives depending on how the embodiment selected by the company.

When implementing the automated scheduling of the presently preferred embodiments, appointment scheduling has increased at least 20% before implementation.

### BRIEF DESCRIPTION OF THE DRAWINGS

The particular features and advantages of the invention as well as other objects will become apparent from the following description taken in connection with the accompanying drawings in which:

The FIGURE is a flow chart showing the methodology of a presently preferred embodiment of the present invention.

### DETAILED DESCRIPTION OF THE PREFERRED EMBODIMENTS

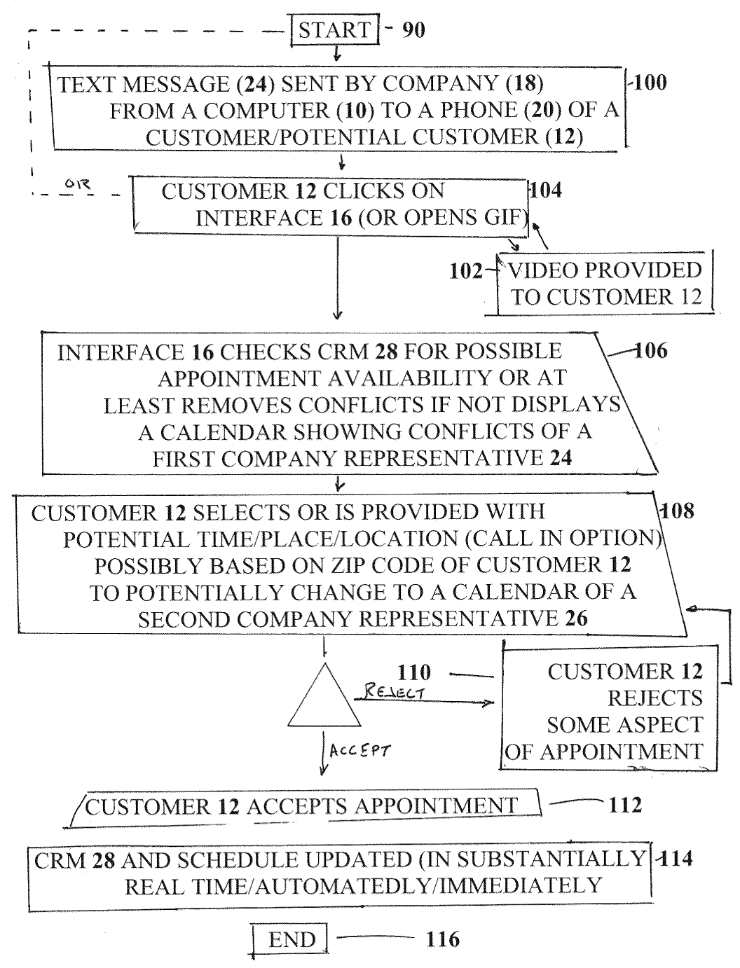

As shown in FIG. 1, a computer 10 sends a text message 14 to one of a customer and potential customer, hereinafter customer/potential customer 12 at step 100. The text message 14 preferably has at least one of (a) an interface such as a link 16 or opens a GIF (18) activating link 16. The customer/potential customer 12 may view a video at step 102 before activating the interface or link 16, and some embodiments may start (step 90) with a user discovering the GIF or link 16 on a computer or other location, however preferred embodiments begin with a text message 14 to the one of the customer/potential customer 12. In fact, when displaying the GIF and/or video, preferably on the phone 20 of the customer/potential customer 12, it is preferred that the text view continue to appear on the screen of a user's phone 20 during this step so that the link 16 may be activated therefrom at step 104. The text message number selected for sending the text message 14 is preferably acquired from a customer relationship management software (CRM system) for many embodiments.

Videos and/or GIF's may be provided to potential customers, or even customers, at steps 102, 104 to advise of new services or need for service so as to prompt a customer/potential customer 12 to schedule an appointment to discuss company 18 providing service(s) for customer/potential customer 12.

With the interface 16 engaged, such as by activating the link or otherwise, the computer displays to the phone 20 of customer/potential customer 12 possible appointment times with a first company representative 24 while taking care to not include times excluded, or unavailable from a calendar of the first company representative, such as earlier scheduled appointments and/or blocked out times, such as lunch, training, meetings, personal time, vacation, doctor's appointments, etc. In fact, for some embodiments, the calendar of the first company representative 24 is displayed to the customer/potential customer 12 with excluded times showing as unavailable blocks of time in some manner, preferably without revealing at least some details, such as the identity of a person an earlier booked appointment may include. In still further embodiments, the calendar is taken from a customer relationship management software program, CRM 28, of the company 18 which is likely maintained in the cloud, such as remotely from company personnel as well as the customer/potential customer 12.

The customer/potential customer 12 may select from a plurality of available appointments and upon making that selection, the selected appointment is immediately added to the calendar of the first company representative 24, and to the extend any other party is provided (either concurrently or later) with available appointments for the first company representative 24, an update is provided so that available appointments do not include times within the selected appointment. For some embodiments, that selected appointment would appear as another unavailable block of time. If another user were viewing potential appointments that included a time within the selected appointment, the conflicting appointment(s) would either be replaced with other alternatives not including a time within the conflict of the selected appointment, removed from the potential appointments, or otherwise addressed so as to not provide an opportunity for another party to select from potential appointments a selected appointment which conflicts with an earlier selected appointment of the first company representative 24 (or any other unavailability on the schedule/calendar of the first company representative 24.

The applicant discovered that providing the same potential appointment times for a first company representative 24 to multiple customers/potential customers 12 resulted in those parties selecting the same appointment time, thus double booking the first company representative and requiring follow-up to reschedule at least one customer/potential customer 12 giving them time to reconsider, and potentially drop the appointment. By removing booked appointments as an option to all other customers/potential customers 12, double booking of the same time is eliminated, and the CRM software 28 may be updated in real time without the company's manpower . . . artificial intelligence at work.

Meanwhile, with the display of the plurality of possible appointment times to the customer/potential customer 12 at step 106, it may be possible for the customer/potential customer 12 to decide that another location, phone call or video call (Zoom, Teams call, etc.,) may be more desirable. For instance, the CRM system 28 likely knows the zip code of the customer/potential customer and can direct the display of the calendar of a first company representative 24 of a close, or even the closest office to that zip code/location. If the customer/potential customer 12 desires a different location, times, appointment option (video or audio), or even a different company representative, the computer may provide the customer/potential customer 12 with options from up to all of the offices of the company, video or audio appointments with either the same or different company representative. See step 110. The customer/potential customer 12 may provide a preferred location, time, type of appointment, etc. which may assist in deciding which of the first and second company representatives 24, 26 to display from their potential appointments.

When different company representatives are selected, either directly or indirectly, the calendar of that next, or second company representative 26 may be displayed with the unavailable times being excluded from appointment options for the second company representative 26. The calendar, or potential appointments, of multiple second company representatives 26 may be displayed in some embodiments. Thus the next, or any of the second company representatives 26. cannot be double booked using this system in the preferred embodiments either.

At step 112, the customer/potential customer 12 selects a selected appointment. Upon selecting that appointment, the CRM system 28 is updated immediately, in particular the calendar of the company representative that will be taking the appointment with the customer/potential customer 12. With this update, to the extent that any other party has received potential appointment times for that company representative, or will in the future, the times of the selected appointment are made unavailable in the displayed potential appointments. For instance, if a calendar is displayed, then the time period of the selected appointment immediately updated as unavailable. Systems such as this prevent double booking over time periods. Any party looking for potential appointments would see that the time of the selected appointment is unavailable. If potential appointments are provided in a non-calendar view, to the extent that a potential appointment includes time contained within a scheduled appointment, that potential appointment would, at a minimum immediately be changed on the screen of the viewer to not include overlap with the scheduled appointment to prevent double booking on the company representative's schedule, if not deleted from the list or potential appointments, and/or replaced with another potential appointment. It may be that sufficient conflicts exist on a calendar of a particular first company representative 24, that a calendar of a second company representative 26 is utilized to provide additional alternatives for the customer/potential customer 12.

The customer/potential customer 12 may be an existing customer, or a potential customer. Marketing teams consistently attempt to attract new customers, and preferred embodiments of the present invention are particularly well adapted to attract new customers from potential customers by automated sending texts to potential customers and having those potential customers schedule appointments with a company representative without creating a conflict for the company representative. Similarly, there may be applications, such as a need for a yearly review, opportunity to sell new goods/services to an existing customer, or other reason, to reach out to an existing customer, to have that customer receive information from a company representative. Once again, the automated systems discussed herein can prevent double booking the schedule of company representatives.

When a customer/potential customer 12 selects a selected appointment, in at least some embodiments, a message, such as text, email etc. may be sent to the appropriate first or second company representative 24, 26 to notify of the new appointment.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A method of automatedly scheduling an appointment ensuring no conflicting appointments comprising the method of:
a. a computer directed to automatedly send a text to a phone of one of a customer and a potential customer, said text having a link to view at least a plurality of appointment options at the computer obtained from at least a portion of a calendar of a first company representative and unavailable times not selectable as appointment options;
b. and if said one of the customer and potential customer selects an appointment time from the plurality of appointment options through the link as a selected appointment, said computer immediately updates said calendar with the selected appointment displayed on the calendar of the first company representative and to the extent other parties are reviewing or will review appointment options, said appointment options are updated, if necessary, to not include times within the selected appointment.

2. The method of claim 1 wherein the one of the customer and potential customer is not presently a customer, and the text further comprises at least one of (a) GIF file on a text viewing screen on the phone and (b) a video which plays while maintaining the text viewing screen on the phone.

3. The method of claim 2 wherein the link is displayed one of during (a) and/or (b) of claim 2 or after one of (a) or (b) has completed while maintaining the text viewing screen on the phone.

4. The method of claim 3 wherein the link sent to the phone relates to a calendar of a company representative physically closest to a zip code of the one of a customer and a potential customer.

5. The method of claim 4 wherein when viewing the calendar on the computer, the one of the customer and potential customer may select a different location from their zip code, and the computer then displays at least a plurality of appointment options at the computer obtained from at least a portion of a calendar of a second company representative with unavailable times not selectable as appointment options, and then
if said one of the customer and potential customer selects an appointment time from the plurality of appointment options through the link as a selected appointment, and when selected, said computer immediately updating said calendar with the selected appointment displayed on the calendar of the second company representative and to the extent other parties are reviewing or will review appointment options, said appointment options are updated to not include times within the selected appointment.

6. The method of claim 4 wherein all possible locations of the company are displayed as options for the one of the customer and potential customer to select therefrom.

7. The method of claim 4 wherein the zip code of the one of the customer and potential customer is known by the computer when sending the text.

8. The method of claim 7 wherein the calendar and the zip code are known within a customer relationship management system on the computer.

9. The method of claim 8 wherein the computer is remote from both the one of the customer and potential customer and the first and second company representatives.

10. The method of claim 5 further comprising the step of sending notice via one of text and email to the second company representative of new appointment.

11. The method of claim 5 wherein the calendar of the second company representative is displayed to the one of the customer and potential customer with prior commitments having at least in indication related to unavailability as an available appointment.

12. The method of claim 11 wherein prior commitments appear as blocks of unavailable time on the calendar.

13. The method of claim 5 wherein the one of the customer and potential customer selects one of (a) an in person meeting, (b) an audio call, and (c) a video conference call.

14. The method of claim 1 further comprising the step of sending notice via one of text and email to the first company representative of new appointment with the one of the customer and potential customer.

15. The method of claim 1 wherein the zip code of the one of the customer and potential customer is known by the computer when sending the text.

16. The method of claim 15 wherein the calendar and the zip code are known within a customer relationship management system on the computer.

17. The method of claim 16 wherein the computer is remote from the one of the customer and potential customer and the first company representatives.
